(19) United States
(12) Patent Application Publication
(10) Pub. No.: US 2026/0238855 A1
(43) Pub. Date: Aug. 13, 2026

(54) METHOD, APPARATUS, DEVICE, AND MEDIUM FOR PUSHING PROCESSING

(71) Applicant: Beijing Youzhuju Network Technology Co., Ltd., Beijing (CN)

(72) Inventor: Huizhen NIU, Beijing (CN)

(21) Appl. No.: 19/161,210

(22) PCT Filed: Mar. 8, 2024
(86) PCT No.: PCT/CN2024/080868

§ 371 Date: Aug. 29, 2025

(30) Foreign Application Priority Data
Mar. 9, 2023 (CN) 202310225961.1

(51) Int. Cl. H04N 21/466; H04N 21/4788

(52) U.S. Cl. CPC H04N 21/4668; H04N 21/4667; H04N 21/4788

(57) ABSTRACT

This disclosure relates to a pushing processing method, apparatus, device, and medium. The method includes: obtaining viewing behavior information of a playing video; if the viewing behavior information satisfies a predetermined object pushing condition, determining at least one candidate pushing object corresponding to the playing video based on the playing video; generating pushing information for at least one target pushing object of the at least one candidate pushing object; and displaying the pushing information on a video playback interface of the playing video. This improves the pushing conversion efficiency of the video, shortens the object pushing path, and enhances the pushing effect.

This application claims priority to Chinese Patent Application No. 2023102259611, filed on Mar. 9, 2023, entitled “METHOD, APPARATUS, DEVICE, AND MEDIUM FOR PUSHING PROCESSING,” the entire contents of which are incorporated herein by reference.

### FIELD

This disclosure relates to the field of computer application technology, and particularly to a pushing processing method, apparatus, device, and medium.

### BACKGROUND

With the development of computer technology, to better provide online services, using video as a carrier for pushing has become a common service method. For example, on online shopping platforms, short videos are used to introduce and promote products.

In related technologies, when pushing objects using video as a carrier, if users are interested in a pushed object, they actively take screenshots, etc., on the client side to search for relevant information about the pushed object, resulting in a long pushing path and poor pushing effect.

### SUMMARY

In order to solve the above technical problem, or at least partially solve the above technical problem, this disclosure provides a pushing processing method, apparatus, device and medium to improve the conversion rate of pushed videos and enhance the pushing effect.

Embodiments of this disclosure provide a pushing processing method. The method includes the following steps: obtaining viewing behavior information of a playing video; if the viewing behavior information satisfies a predetermined object pushing condition, determining at least one candidate pushing object corresponding to the playing video based on the playing video; generating pushing information for at least one target pushing object from of the candidate pushing objects; and displaying the pushing information on a video playback interface of the playing video.

Embodiments of this disclosure also provide a pushing processing apparatus, including: an obtaining module configured to obtain viewing behavior information of a playing video; a determining module configured to determine at least one candidate pushing object corresponding to the playing video based on the playing video when the viewing behavior information satisfies a predetermined object pushing condition; a generating module configured to generate pushing information for at least one target pushing object of the at least one candidate pushing objects; and a pushing processing module configured to display the pushing information on the video playback interface of the playing video.

Embodiments of this disclosure further provide an electronic device, including: a processor; and memory storing processor-executable instructions, wherein the processor executes the instructions to implement the pushing processing method as provided in this disclosure.

Embodiments of this disclosure further provide a computer-readable storage medium. The storage medium stores a computer program, and the computer program, when executed, performs the pushing processing method provided in this disclosure.

### BRIEF DESCRIPTION OF THE DRAWINGS

The foregoing and other features, advantages, and aspects of the various embodiments of this disclosure will become more apparent from the following detailed description when taken in conjunction with the accompanying drawings, in which similar reference characters refer to similar elements throughout. It should be understood that the drawings are schematic and not necessarily drawn to scale.

FIG. 1 is a flowchart illustrating a pushing processing method according to an embodiment of this disclosure.

FIG. 2 is a schematic diagram of a pushing scenario according to an embodiment of this disclosure.

FIG. 3 is a schematic diagram of another pushing scenario according to an embodiment of this disclosure.

FIG. 4 is a schematic diagram of another pushing scenario according to an embodiment of this disclosure.

FIG. 5 is a schematic diagram of another pushing scenario according to an embodiment of this disclosure.

FIG. 6 is a structural diagram of a pushing processing apparatus according to an embodiment of this disclosure.

FIG. 7 is a structural diagram of an electronic device according to an embodiment of this disclosure.

### DETAILED DESCRIPTION

The embodiments of this disclosure will be described in further detail with reference to the accompanying drawings. While certain embodiments are shown, it is understood that this disclosure may be embodied in various forms and should not be construed as limited to the embodiments set forth herein. Rather, these embodiments are provided for thoroughness and completeness, and to fully convey the scope to those skilled in the art. The drawings and described embodiments are for illustrative purposes and are not meant to limit the scope of this disclosure.

It should be understood that the steps described in the method embodiments can be performed in different orders and/or concurrently. Additional steps may be included, and/or illustrated steps omitted, without departing from the scope of this disclosure.

As used herein, the term “comprising” and its variations are open-ended, meaning “including, but not limited to.” The term “based on” means “at least partially based on.” The terms “one embodiment,” “another embodiment,” and “some embodiments” mean “at least one embodiment,” “at least one other embodiment,” and “at least some embodiments,” respectively. Definitions of other terms will be provided in the following description.

The terms “first,” “second,” etc., are used merely to distinguish between different devices, modules, or units and do not imply any particular order or dependency of operation of such devices, modules, or units.

The terms “a” or “an” and “one or more” are used interchangeably and are intended to be non-limiting. Those skilled in the art will understand that unless otherwise clearly indicated by context, “a,” “an,” or “one or more” should be interpreted as meaning “one or more.”

The names of messages or information exchanged between multiple devices in the embodiments of this disclosure are for illustrative purposes only and do not limit the scope of such messages or information.

To address the aforementioned problems, this disclosure provides a pushing processing method. In this method, when it is determined that a client may have a need for a push related to a video pushing object in a playing video, a push of the relevant pushing object is performed, shortening the search path for the pushing object, improving the conversion efficiency of video pushes, and enhancing the pushing effect.

Compared with the prior art, the technical solution provided in this disclosure has the following advantages.

The pushing processing solution obtains viewing behavior information of a playing video. If the viewing behavior information satisfies a predetermined object pushing condition, it determines at least one candidate pushing object corresponding to the playing video based on the playing video. Then, it generates pushing information for at least one target pushing object from the candidate pushing objects and displays the pushing information on a video playback interface of the playing video. This embodiment improves the pushing conversion efficiency of videos, shortens the object pushing path, and enhances the pushing effect.

The method will now be described in conjunction with specific embodiments.

FIG. 1 is a flowchart illustrating a pushing processing method, according to an embodiment of this disclosure. The method can be performed by a pushing processing apparatus, which can be implemented using software and/or hardware, and is typically integrated into an electronic device. As shown in FIG. 1, the method includes:

Step 101: Obtaining viewing behavior information of a playing video.

The playing video can be a video pushed by a pushing platform, etc. The method of pushing this video can be realized by embedding a link related to the video pushing object in the video, or by providing pushing description information such as the reason for pushing the video, the video content, etc., to achieve the pushing of the relevant video pushing object.

Step 102: If the viewing behavior information satisfies a predetermined object pushing condition, determining at least one candidate pushing object corresponding to the playing video based on the playing video.

Viewing behavior information can be understood as relevant operations performed on the playing video when the client is viewing the playing video. Viewing behavior information includes, but is not limited to, liking behavior, commenting behavior, screenshotting behavior, sharing behavior, viewing duration, etc., for the playing video.

In one embodiment of this disclosure, the viewing behavior information of the playing video is obtained, and based on the viewing behavior information, it is determined whether the predetermined object pushing condition is met. If the predetermined object pushing condition is met, subsequent pushing processing is performed for the client.

In some possible embodiments, viewing behavior information indicating that the predetermined object pushing condition is met can be predefined. When the viewing behavior information belongs to the predefined viewing behavior information, it is determined that the viewing behavior information satisfies the predetermined object pushing condition. The predetermined viewing behavior information includes one or more of liking behavior, commenting behavior, screenshotting behavior, and sharing behavior for the playing video. For example, if it is determined that the client has shared the playing video, then it is determined that the viewing behavior information satisfies the predetermined object pushing condition.

In some possible embodiments, if the viewing behavior information includes viewing duration, and if the viewing duration is greater than a predetermined viewing duration threshold, it is determined that the viewing behavior satisfies the predetermined object pushing condition.

Further, when the viewing behavior information satisfies the predetermined object pushing condition, at least one candidate pushing object corresponding to the playing video is determined based on the playing video.

The method for determining at least one candidate pushing object varies depending on the application scenario. Examples are provided below:

In some possible implementations, a video pushing object corresponding to the playing video is determined. The video pushing object can be understood as the object displayed or introduced in the video content of the playing video. For example, if the object displayed or introduced in the video content is a shirt, the shirt can be considered the video pushing object of the playing video. In this embodiment, the video pushing object corresponding to the playing video can be determined based on one or more of the video frame content corresponding to the playing video and the video description content corresponding to the playing video. The video description content can include video copy information and predetermined video pushing reasons.

In this embodiment, the current video pushing object can be solely used as the candidate pushing object. To further enhance the pushing effect, the candidate pushing objects can be enriched. That is, associated pushing objects related to the video pushing object are determined, and the video pushing object and the associated pushing objects are determined as the at least one candidate pushing object. Thus, in this embodiment, not only can the current video pushing object be used as a candidate pushing object, but also the associated pushing objects related to the video pushing object can be used as candidate pushing objects, increasing the richness of the candidate pushing objects.

It should be noted that the method for determining associated pushing objects varies in different application scenarios. Examples are as follows:

In some possible embodiments, the first object characteristic information of the video pushing object is determined. The first object characteristic information includes category information, style information, etc., of the corresponding video pushing object, which describe the characteristics of the video pushing object in any dimension. Then, the associated pushing objects are determined based on the first object characteristic information. There can be one or more associated pushing objects, and each associated pushing object can contain at least one first pushing sub-object. The at least one first pushing sub-object contains at least one second pushing sub-object, and the object characteristic similarity between the second object characteristic information of the second pushing sub-object and the first object characteristic information is greater than a predetermined object characteristic similarity threshold. The second object characteristic information includes category information, style information, etc., of the corresponding second pushing sub-object. Therefore, in this embodiment, the obtained associated pushing objects can contain only the second pushing sub-objects similar to the video pushing object, or they can contain other first pushing sub-objects in addition to the second sub-objects similar to the video pushing object. This further enhances the pushing effect.

For example, when the associated pushing object contains only one second pushing sub-object, if the video pushing object is shirt A, then each associated pushing object containing one second pushing sub-object is also a single item such as shirt B, and the similarity between the second object characteristic information of shirt B corresponding to each associated pushing object and the first object characteristic information of shirt A, the video pushing object, is greater than the predetermined object characteristic similarity threshold. For example, if the video pushing object is outfit C, then each associated pushing object containing one second pushing sub-object is outfit D, etc., and the similarity between the second object characteristic information of outfit D corresponding to each associated pushing object and the first object characteristic information of outfit C, the video pushing object, is greater than the predetermined object characteristic similarity threshold.

For example, when the associated pushing object contains other first pushing sub-objects in addition to the second pushing sub-object, if the video pushing object is shirt E, and the corresponding second pushing sub-object is shirt F, then the associated pushing object can be an outfit object containing shirt F, an item collection object containing shirt F, etc., and the similarity between the second object characteristic information of shirt F corresponding to each associated pushing object and the first object characteristic information of shirt E, the video pushing object, is greater than the predetermined object characteristic similarity threshold. For example, if the video pushing object is outfit G, then the associated pushing object can be an item collection object containing outfit H, and the similarity between the second object characteristic information of outfit H corresponding to each associated pushing object and the first object characteristic information of outfit G, the video pushing object, is greater than the predetermined object characteristic similarity threshold.

Step 103: Generating pushing information for at least one target pushing object of the at least one candidate pushing object, and displaying the pushing information on a video playback interface of the playing video.

In one embodiment of this disclosure, after obtaining at least one candidate pushing object, at least one target pushing object of the candidate pushing objects is determined. For example, the total number of pushes for each candidate pushing object within a predetermined time period from the current time is obtained, and at least one target pushing object is determined in descending order based on the total number of pushes. Alternatively, the candidate pushing objects can be sorted according to any sorting rule, and at least one candidate pushing object is selected as the target pushing object in the order from front to back in the sorted result. The display count for selecting target pushing objects depends on the scenario and can be set according to the needs of the scenario.

After at least one target pushing object is determined, pushing information for the target pushing object(s) is generated. In some possible implementations, the pushing information can include object description information of the target pushing object. This object description information can include descriptive information such as object images and required resources of the target pushing object. When the target pushing object contains multiple pushing elements, the object description information can include image information, etc., of at least one pushing element.

In some possible implementations, the pushing information may also include target comment information. The target comment information belongs to at least one piece of candidate comment information of the at least one target pushing object. For example, the comment popularity value of at least one piece of candidate comment information for at least one target pushing object can be determined in advance based on the number of likes, etc. The comment popularity value can be proportional to the number of likes, etc. The at least one piece of candidate comment information is sorted in descending order of comment popularity value, and the corresponding candidate comment information is selected as the target comment information according to a predetermined display count in the order from front to back in the sorting result. For example, to make the target comment information more relevant to the playing video, the target comment information can also be determined solely based on the above method from the current at least one piece of candidate comment information of the video pushing object. For example, the number of likes, etc. for each candidate comment information in the current at least one piece of candidate comment information of the video pushing object can be determined, and the comment popularity value of at least one piece of candidate comment information for at least one target pushing object can be determined based on the number of likes, etc. The comment popularity value can be proportional to the number of likes, etc. The candidate comment information is sorted in descending order based on the comment popularity value, and the corresponding candidate comment information is selected as the target comment information according to the predetermined display count and the order from front to back in the sorting result.

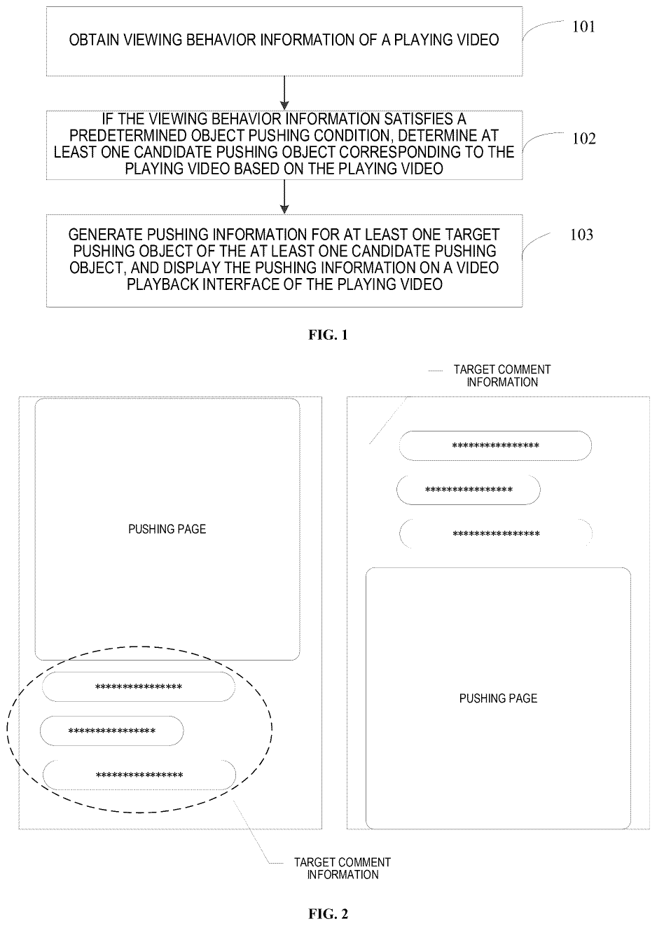

Furthermore, the pushing information is displayed on the video playback interface of the playing video. For example, if the pushing information includes the object description information of the target pushing object, a pushing page can be displayed on the video playback interface. The pushing page contains pushing areas corresponding to each target pushing object, and each pushing area displays the corresponding description information of the target pushing object. As shown in FIG. 2, the pushing page can be displayed in an upward sliding or downward sliding manner, etc., and these are not listed here one by one. Thus, the pushing page containing the pushing information including the target pushing object can be obtained without the need for active searching by the client. If the pushing information also contains a service jump page link corresponding to the target pushing object, when the client clicks any service jump page link, a jump to the service page for the relevant target pushing object can be made. The corresponding service page provides services related to the target pushing object, and the specific service content of these services can be set according to the needs of the scenario.

In some possible embodiments, the pushing information also includes target comment information, and thus, when the pushing information is displayed, the target comment information can also be displayed. As shown in FIG. 2, the target comment information can be displayed in a barrage component style on the video playback interface. The display area for the target comment information is different from the display area for the pushing page, to prevent them from occluding each other.

In actual implementation, to further ensure the pushing effect, in some possible embodiments, the first number of the candidate pushing objects can be counted before displaying pushing information to the client, to confirm that the first number is greater than the first predetermined number threshold. The first predetermined number threshold can be calibrated based on the specific needs of the scenario. For example, the first predetermined number threshold can be 15, meaning that the pushing process is executed only when the first number is relatively large.

In some possible embodiments, to further enhance the effectiveness of pushing information, before the client displays pushing information, it is also determined whether the client can perform the pushing information's pushing processing.

In this embodiment, the historical operation information performed on the client side is determined for each history pushing information. The historical operation information is about operations related to historical pushing information performed by the client side. It may, for example, include trigger behavior information (e.g., trigger times, trigger frequency) corresponding to predetermined controls of history pushing information and also, for example, include the average watch duration of each piece of historical pushing information. In some alternative examples, when the history card operation information performed by the client side is determined for the historical pushing card, it can optionally select the historical pushing information during a pre-set period before the current time point.

In this embodiment, if, according to the historical pushing information, it is determined that the client fulfills the pre-set pushing condition, then pushing process can be done at the client side. Otherwise pushing process will not be executed.

In different application scenarios, historical card operation information will be different, which will result in various methods used to determine if a client satisfies predetermined pushing card condition, some examples will be discussed below:

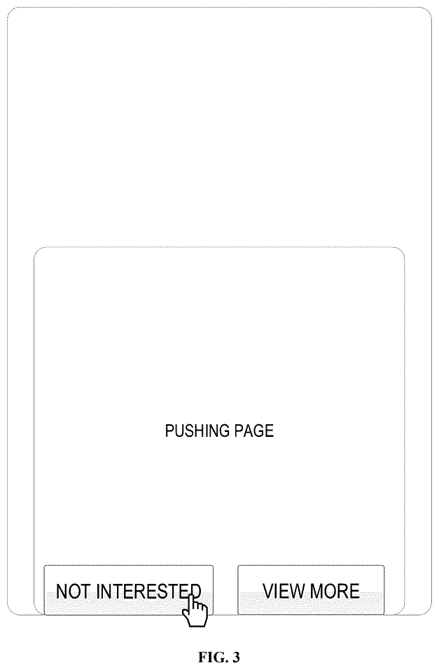

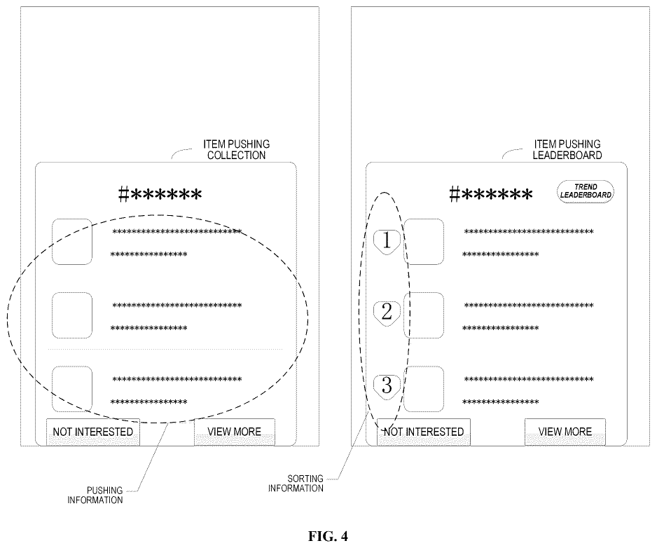

In some possible implementation method as demonstrated in FIG. 3, The pushing card contains pre-set controls like ‘Not interested’, the history card information includes the number of total click times for pre-set control. If the total number exceeds the threshold, then the pre-set pushing card condition will be considered as met.

In some possible implementation method, the historical card operation information could include the average viewing duration for historical pushed videos. If the average viewing duration surpasses the pre-set view duration, then pre-set card pushing condition will be fulfilled.

In summary, the pushing processing method of this embodiment obtains viewing behavior information of a playing video and determines at least one candidate pushing object corresponding to the playing video based on the playing video when the viewing behavior information satisfies a predetermined object pushing condition. Then, it generates pushing information for at least one target pushing object from the candidate pushing objects and displays the pushing information on a video playback interface of the playing video. This embodiment improves the pushing conversion rate of videos, shortens the object pushing path, and enhances the pushing effect.

The following examples describe how to select the at least one target pushing object from the candidate pushing objects.

In some possible embodiments, a leaderboard database is maintained in advance. The leaderboard database contains multiple leaderboard pushing objects, and each leaderboard pushing object has a corresponding pushing popularity, which can be determined based on the historical click-through rate. That is, each time a leaderboard pushing object is pushed to the corresponding client, in response to receiving a click instruction for the leaderboard pushing object on the client, the current total pushing count and current total click count of the leaderboard pushing object are determined. The pushing popularity of the leaderboard pushing object is calculated as the ratio of the current total click count to the current total pushing count according to the calculation logic of Click-Through-Rate (CTR).

In one embodiment of this disclosure, it is identified whether each candidate pushing object belongs to a predetermined leaderboard database, and the second number of candidate pushing objects belonging to the predetermined leaderboard database is determined. The leaderboard database contains multiple leaderboard pushing objects sorted in descending order according to a predefined pushing popularity.

If the second number is greater than or equal to a second predetermined number threshold, a predetermined display number of candidate pushing objects of those belonging to the leaderboard database are determined as the target pushing objects in sequential order from the beginning of the leaderboard database. The second predetermined number threshold can be calibrated based on the needs of the scenario.

In this embodiment, when there are multiple target pushing objects, the predetermined leaderboard database can be queried to determine the pushing popularity corresponding to each target pushing object. The target pushing objects are sorted in descending order of pushing popularity. The sequence number and other sorting information for each target pushing object are determined based on the sorting result. The target pushing objects can be arranged on the pushing page based on their respective sorting information with this information also being displayed.

In another embodiment of this disclosure, if the second number of candidate pushing objects belonging to the predetermined leaderboard database is less than the second predetermined number threshold, a ranking factor for each candidate pushing object is obtained. This ranking factor can include at least one of the predetermined rating information about the candidate pushing object, the predetermined object's popularity information, and the relevance to the video pushing object corresponding to the playing video. A sorting reference value is determined for each candidate pushing object based on the value of the ranking factor. For example, each ranking factor is normalized, and the sum of all pushing factors for each candidate pushing object is used to obtain its corresponding ranking reference value. Then, the candidate pushing objects are sorted in descending order of the sorting reference values to generate a ranking result. A predetermined display number of candidate pushing objects are determined as the target pushing objects based on the sequential order from beginning to end in the sorting result. The predetermined display number is related to the pushing scenario of the pushing card, and for instance, can be 3. This embodiment can be considered as displaying the pushing card as an “object collection.”

That is, in this embodiment, it is first determined whether candidate pushing objects can be displayed as a leaderboard. If not, they are displayed as a collection. Since the leaderboard display can push target pushing objects more intuitively, its display priority is higher than that of the collection display.

For example, if the video pushing object is a single item, the pushing page generated based on the above embodiments can be a collection type, as shown on the left side of FIG. 4, or a leaderboard type, as shown on the right side of FIG. 4. Similarly, if the first pushing element is a collection of items, the pushing page generated according to the above embodiments can be a collection type as shown on the left of FIG. 5 or a leaderboard type as shown on the right of FIG. 5.

In actual implementation, when generating the pushing page, to further enhance the pushing effect, the video pushing object can also be consistently displayed at the top of the pushing page.

In summary, in the pushing processing method of this embodiment, target pushing objects can be flexibly determined based on scenario requirements and displayed in a specific order, thereby further improving the effectiveness of the pushes.

To implement the above embodiments, this disclosure also provides a pushing processing apparatus.

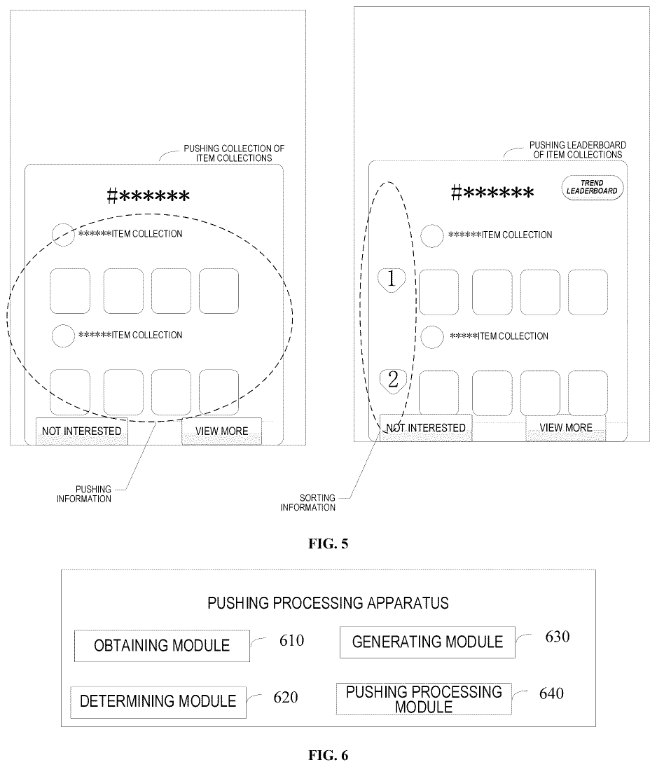

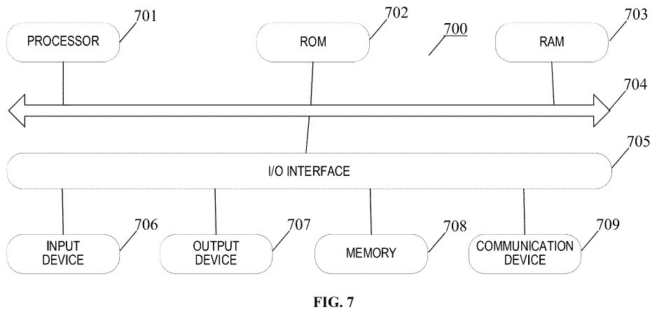

FIG. 6 is a structural diagram of a pushing processing apparatus according to an embodiment of this disclosure. The apparatus can be implemented by software and/or hardware and is typically integrated into an electronic device for pushing processing. As shown in FIG. 6, the apparatus includes an obtaining module 610, a determining module 620, a generating module 630, and a pushing processing module 640.

The acquisition module 610 is configured to acquire viewing behavior information of the playing video.

The obtaining module 610 is configured to obtain viewing behavior information of a playing video. The determining module 620 is configured to determine at least one candidate pushing object corresponding to the playing video based on the playing video if the viewing behavior information satisfies the predetermined object pushing condition.

The generating module 630 is configured to generate pushing information for at least one target pushing object of the candidate pushing objects.

The pushing processing module 640 is configured to display the pushing information on the video playback interface of the playing video.

The pushing processing apparatus provided by this embodiment can execute the pushing processing method provided by any of the disclosed embodiments. It includes functional modules for executing the methods as well as all advantages brought thereby, and a description of same will not be repeated herein.

To implement the above embodiments, this disclosure also proposes a computer program product, including a computer program/instructions which, when executed by a processor, implements the pushing processing method in the above embodiments.

FIG. 7 is a structural diagram of an electronic device according to an embodiment of this disclosure.

With specific reference to FIG. 7, the figure shows a schematic structural diagram of electronic device 700 suitable for use in implementing the present disclosure. Electronic device 700 can include, but is not limited to mobile terminals such as mobile phones, laptop computers, digital broadcast receivers, personal digital assistants (PDAs), tablet PCs (PADs), portable multimedia players (PMPs), in-vehicle terminals (e.g., in-vehicle navigation terminals), and stationary terminals such as digital TVs and desktop computers. The electronic device shown in FIG. 7 is only an example and should not impose any limitations on the functionality and scope of use of the embodiments of the disclosure.

As shown in FIG. 7, the electronic device 700 can include a processor 701 (e.g., a central processing unit, graphics processor, etc.), which executes various appropriate actions and processes according to programs stored in read-only memory (ROM) 702 or programs loaded from a memory 708 into random access memory (RAM) 703. RAM 703 also stores various programs and data needed for the electronic device's operation. The processor 701, ROM 702, and RAM 703 are interconnected via a bus 704. An input/output (I/O) interface 705 is also connected to bus 704.

Typically, the following devices can be connected to the I/O interface 705: an input device 706 including, for example, a touch screen, touchpad, keyboard, mouse, camera, microphone, accelerometer, gyroscope, etc.; an output device 707 including, for example, a liquid crystal display (LCD), speaker, vibrator, etc.; a memory 708 including, for example, magnetic tape, hard disk, etc.; and a communication device 709. The communication device 709 enables the electronic device 700 to communicate wirelessly or wiredly with other devices to exchange data. While FIG. 7 illustrates an electronic device 700 with various components, it is understood that not all illustrated components are required to be implemented or present. More or fewer components may be alternatively implemented or present.

Specifically, according to the embodiments of this disclosure, the processes described above with reference to the flowcharts can be implemented as computer software programs. For example, the embodiments of this disclosure include a computer program product comprising a computer program embodied on a non-transitory computer-readable medium, the computer program including program code for performing the methods illustrated in the flowcharts. In such embodiments, the computer program can be downloaded and installed from a network via the communication device 709, or installed from the memory 708 or the ROM 702. When executed by the processor 701, the computer program performs the functions described above as defined in the pushing processing method of this disclosure.

It should be noted that the computer-readable medium described above can be a computer-readable signal medium or a computer-readable storage medium, or any combination thereof. The computer-readable storage medium can be, for example, but is not limited to, an electrical, magnetic, optical, electromagnetic, infrared, or semiconductor system, apparatus, or device, or any combination thereof. More specific examples of the computer-readable storage medium can include, but are not limited to: an electrical connection having one or more wires, a portable computer diskette, a hard disk, random access memory (RAM), read-only memory (ROM), erasable programmable read-only memory (EPROM or Flash memory), an optical fiber, a portable compact disc read-only memory (CD-ROM), an optical storage device, a magnetic storage device, or any suitable combination of the foregoing. In this disclosure, a computer-readable storage medium can be any tangible medium that can contain or store a program usable by or in connection with an instruction execution system, apparatus, or device. A computer-readable signal medium can include a propagated data signal with computer-readable program code embodied therein, whether in baseband or as part of a carrier wave. Such a propagated data signal can take many forms, including, but not limited to, electro-magnetic, optical, or any suitable combination thereof. A computer-readable signal medium can be any computer-readable medium that is not a computer-readable storage medium and that can communicate, propagate, or transport a program for use by or in connection with an instruction execution system, apparatus, or device. Program code embodied on a computer-readable medium can be transmitted using any appropriate medium, including but not limited to wireless, optical cable, RF, etc., or any suitable combination of the foregoing.

In some embodiments, the client and server can communicate using any currently known or later-developed network protocol, such as HTTP (HyperText Transfer Protocol), and can be interconnected with any form or medium of digital data communication (e.g., a communication network). Examples of communication networks include local area networks (“LANs”), wide area networks (“WANs”), the Internet, and peer-to-peer networks (e.g., ad-hoc peer-to-peer networks), as well as any currently known or later-developed network.

The computer-readable medium described above can be included in the electronic device described above or can exist separately and not be integrated into the electronic device.

The computer-readable medium described above stores one or more programs that, when executed by the electronic device, cause the electronic device to:
obtain viewing behavior information of a playing video; if the viewing behavior information satisfies a predetermined object pushing condition, determine at least one candidate pushing object corresponding to the playing video based on the playing video; generate pushing information for at least one target pushing object from the at least one candidate pushing object; and display the pushing information on a video playback interface of the playing video. This improves the conversion efficiency of video pushes, shortens the object pushing path, and enhances the pushing effect.

The computer program code for carrying out the operations disclosed herein may be written in one or more programming languages, or combinations thereof, including, without limitation, object-oriented programming languages such as Java, Smalltalk, C++, and conventional procedural programming languages, such as the “C” programming language or similar programming languages. The program code may execute entirely on the user's computer, partly on the user's computer, as a stand-alone software package, partly on the user's computer and partly on a remote computer or entirely on a remote computer or server. In the latter scenario, the remote computer may be connected to the user's computer through any type of network, including a local area network (LAN) or a wide area network (WAN), or the connection may be through an external computer (for example, through the Internet using an Internet service provider).

The flow charts and block diagrams in the Figures illustrate the architecture, functionality, and operation of possible implementations of systems, methods and computer program products according to various embodiments of the present disclosure. In this regard, each block in the flow charts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently or the blocks may sometimes be executed in the reverse order, depending upon the functionality involved. It is also noteworthy that each block of the block diagrams and/or flowcharts, and combinations of blocks in the block diagrams and/or flowcharts, can be implemented by special purpose hardware-based systems which perform the specified functions or acts or by combinations of special purpose hardware and computer instructions.

The units involved in the embodiments described herein may be implemented in software or hardware. The names of the units do not limit the units themselves.

The functions described herein may be performed, at least in part, by one or more hardware logic components. Exemplary types of hardware logic components that may be used include, but are not limited to, field programmable gate arrays (FPGAs), application-specific integrated circuits (ASICs), application-specific standard products (ASSPs), system-on-a-chip (SOC) circuits, complex programmable logic devices (CPLDs), and the like.

In the context of this disclosure, a machine-readable medium may be a tangible medium capable of containing or storing the program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of the machine-readable storage medium would include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

The foregoing description is presented as illustrative of the principles of the invention and of preferred embodiments. It should be understood by those skilled in the art that the scope of the disclosure encompasses not only the described embodiments, but also any and all equivalents, modifications, variations, or alterations without departing from the spirit and scope of the present invention as defined by the appended claims. For example, the described features can be replaced by features described elsewhere in this disclosure (but not limited thereto) which have similar functionality.

Moreover, while operations are depicted in a particular order, this should not be understood as requiring that such operations be performed in the particular order shown or in sequential order. In certain circumstances, multitasking and parallel processing may be advantageous. Likewise, while several specific implementation details are included in the foregoing discussion, these should not be interpreted as limitations on the scope of the invention. Certain features that are described in the context of separate embodiments can also be implemented in combination in a single embodiment. Conversely, various features that are described in the context of a single embodiment can also be implemented in multiple embodiments separately or in any suitable sub-combination.

While the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-14. (canceled)

15. A pushing processing method, comprising:
obtaining viewing behavior information of a video;
in accordance with a determination that the viewing behavior information satisfies a predetermined object pushing condition, determining at least one candidate pushing object corresponding to the video based on the video; and
generating pushing information for at least one target pushing object of the at least one candidate pushing object, and displaying the pushing information on a video playback interface of the video.

16. The method of claim 15, further comprising:
in accordance with a determination that the viewing behavior information belongs to predetermined viewing behavior information, determining that the viewing behavior information satisfies the predetermined object pushing condition, and wherein
the predetermined viewing behavior information comprises one or more of a liking behavior, commenting behavior, screenshotting behavior, or sharing behavior for the video.

17. The method of claim 15, wherein determining the at least one candidate pushing object corresponding to the video comprises:
determining a video pushing object corresponding to the video, and determining an associated pushing object associated with the video pushing object; and
determining the video pushing object and the associated pushing object as the at least one candidate pushing object.

18. The method of claim 17, wherein determining the associated pushing object associated with the video pushing object comprises:
identifying first object characteristic information of the video pushing object, and determining the associated pushing object based on the first object characteristic information, wherein
the associated pushing object is one of at least one associated pushing object and each associated pushing object comprises at least one first pushing sub-object, and the at least one first pushing sub-object comprises at least one second pushing sub-object, an object characteristic similarity between second object characteristic information of each second pushing sub-object and the first object characteristic information being greater than a predetermined object characteristic similarity threshold.

19. The method of claim 17, wherein determining the video pushing object corresponding to the video comprises:
identifying at least one of video frame content, a video-carrying object, or video description content corresponding to the video; and
determining the video pushing object corresponding to the video based on the at least one of the video frame content, the video-carrying object, or the video description content.

20. The method of claim 15, further comprising before generating the pushing information for the at least one target pushing object of the at least one candidate pushing object:
counting a first number of the at least one candidate pushing object; and
in accordance with a determination that the first number is greater than a first predetermined number threshold, executing the step of generating the pushing information for the at least one target pushing object of the at least one candidate pushing object.

21. The method of claim 15, further comprising before displaying the pushing information on the video playback interface of the video:
determining historical operation information corresponding to historical pushing information; and
in accordance with a determination based on the historical operation information that a client satisfies a predetermined information pushing condition, executing the step of displaying the pushing information on the video playback interface of the video.

22. The method of claim 15, comprising before generating the pushing information of at least one target pushing object of the at least one candidate pushing objects:
identifying whether each candidate pushing object belongs to a predetermined leaderboard database, and determining a second number of candidate pushing objects that belong to the predetermined leaderboard database, wherein the leaderboard database comprises a plurality of leaderboard pushing objects sorted from high to low according to a predetermined pushing popularity; and
in accordance with a determination that the second number is greater than or equal to a second predetermined number threshold, determining a predetermined display number of candidate pushing objects as the target pushing objects from the candidate pushing objects that belong to the leaderboard database in a sequential order from top to bottom in the leaderboard database.

23. The method of claim 22, further comprising after determining the second number of candidate pushing objects belonging to the predetermined leaderboard database:
in accordance with a determination that the second number is smaller than the second predetermined number threshold, obtaining a sorting factor for each candidate pushing object, wherein the sorting factor comprises at least one of predetermined scoring information, predetermined object popularity information, and relevance to the video pushing object corresponding to the video for each candidate pushing object;
determining a sorting reference value for each candidate pushing object based on the sorting factor, and generating a sorted result by sorting the at least one candidate pushing object in descending order according to the sorting reference value; and
determining a predetermined display number of candidate pushing objects as the target pushing objects according to a sequential order from top to bottom in the sorted result.

24. The method of claim 15, wherein the pushing information comprises object description information of the target pushing object, and displaying the pushing information on the video playback interface of the video comprises:
displaying a pushing page on the video playback interface, wherein the pushing page comprises a pushing area corresponding to each target pushing object, and the pushing area displays the corresponding object description information of the target pushing object.

25. The method of claim 24, wherein the pushing information further comprises: target comment information, wherein the target comment information belongs to at least one piece of candidate comment information of the at least one target pushing object, and displaying the pushing information on the video playback interface of the video further comprises:
displaying the target comment information on the video playback interface.

26. An electronic device, wherein the electronic device comprises:
a processor;
a memory storing processor-executable instructions;
the processor configured to read the executable instructions from the memory and execute the executable instructions to perform acts comprising:
obtaining viewing behavior information of a video;
in accordance with a determination that the viewing behavior information satisfies a predetermined object pushing condition, determining at least one candidate pushing object corresponding to the video based on the video; and
generating pushing information for at least one target pushing object of the at least one candidate pushing object, and displaying the pushing information on a video playback interface of the video.

27. The electronic device of claim 26, the acts further comprising:
in accordance with a determination that the viewing behavior information belongs to predetermined viewing behavior information, determining that the viewing behavior information satisfies the predetermined object pushing condition, and wherein
the predetermined viewing behavior information comprises one or more of a liking behavior, commenting behavior, screenshotting behavior, or sharing behavior for the video.

28. The electronic device of claim 26, wherein determining the at least one candidate pushing object corresponding to the video comprises:
determining a video pushing object corresponding to the video, and determining an associated pushing object associated with the video pushing object; and
determining the video pushing object and the associated pushing object as the at least one candidate pushing object.

29. The electronic device of claim 28, wherein determining the associated pushing object associated with the video pushing object comprises:
identifying first object characteristic information of the video pushing object, and determining the associated pushing object based on the first object characteristic information, wherein
the associated pushing object is one of at least one associated pushing object and each associated pushing object comprises at least one first pushing sub-object, and the at least one first pushing sub-object comprises at least one second pushing sub-object, an object characteristic similarity between second object characteristic information of each second pushing sub-object and the first object characteristic information being greater than a predetermined object characteristic similarity threshold.

30. The electronic device of claim 28, wherein determining the video pushing object corresponding to the video comprises:
identifying at least one of video frame content, a video-carrying object, or video description content corresponding to the video; and
determining the video pushing object corresponding to the video based on the at least one of the video frame content, the video-carrying object, or the video description content.

31. The electronic device of claim 26, the acts further comprising before generating the pushing information for the at least one target pushing object of the at least one candidate pushing object:
counting a first number of the at least one candidate pushing object; and
in accordance with a determination that the first number is greater than a first predetermined number threshold, executing the step of generating the pushing information for the at least one target pushing object of the at least one candidate pushing object.

32. The electronic device of claim 26, the acts further comprising before displaying the pushing information on the video playback interface of the video:
determining historical operation information corresponding to historical pushing information; and
in accordance with a determination based on the historical operation information that a client satisfies a predetermined information pushing condition, executing the step of displaying the pushing information on the video playback interface of the video.

33. The electronic device of claim 26, the acts comprising before generating the pushing information of at least one target pushing object of the at least one candidate pushing objects:
identifying whether each candidate pushing object belongs to a predetermined leaderboard database, and determining a second number of candidate pushing objects that belong to the predetermined leaderboard database, wherein the leaderboard database comprises a plurality of leaderboard pushing objects sorted from high to low according to a predetermined pushing popularity; and
in accordance with a determination that the second number is greater than or equal to a second predetermined number threshold, determining a predetermined display number of candidate pushing objects as the target pushing objects from the candidate pushing objects that belong to the leaderboard database in a sequential order from top to bottom in the leaderboard database.

34. A non-transitory computer-readable storage medium storing a computer program, the computer program configured to perform acts comprising:
obtaining viewing behavior information of a video;
in accordance with a determination that the viewing behavior information satisfies a predetermined object pushing condition, determining at least one candidate pushing object corresponding to the video based on the video; and
generating pushing information for at least one target pushing object of the at least one candidate pushing object, and displaying the pushing information on a video playback interface of the video.
